(19) United States
(12) Patent Application Publication
(10) Pub. No.: US 2004/0066984 A1
(43) Pub. Date: Apr. 8, 2004

(54) Built-in zipper bag and manufacturing method thereof

(76) Inventor: Jenny Jie Yi Li, Los Angeles, CA (US)

Correspondence Address: Raymond Y. Chan, Suite 128, 108 N. Ynez Avenue, Monterey Park, CA, 91754, US

(21) Appl. No.: 10/263,877

(22) Filed: Oct. 4, 2002

(51) Int. Cl. B65D 33/16; B31B 1/84

(52) U.S. Cl. 383/64; 493/213

(57) ABSTRACT

A zipper bag includes a bag body having two opening edges, and a zipper arrangement including two zipping fasteners integrally attached along the opening edges of the bag body respectively to form a pair of sliding engagement rails, two stopper ends provided at two ends of the zipper arrangement, and a zip locker, having a guider arm, which is slidably mounted on the sliding rail and arranged in such a manner that when the zip locker is slid to one of the stopper ends of the sliding rail, the guider arm is slidably guided to unfasten the two zipping fasteners with each other, and when the zip locker is slid to the other stopper end of the sliding rail, the two zipping fasteners are guided to fasten with each other so as to enclose a storage cavity of the bag body in an airtight manner.

### BACKGROUND OF THE PRESENT INVENTION

1. Field of Invention

The present invention relates to a zipper bag, and more particularly to a built-in zipper bag and a manufacturing method thereof, wherein the built-in zipper bag includes a zipper arrangement securely zipping up a bag body of the zipper bag in an airtight manner.

2. Description of Related Arts

Zipper bags are known in art for storing food in an airtight manner. Generally speaking, there are two types of zipper bag, which are the integral type and the zip locker type.

The integral type zipper bag comprises a bag body having an opening and a storage cavity, a first zipper attached along one opening edge, and a second zipper attached along another opening edge such that when the first and second zippers are attached with each other to enclose the opening of the bag body, the storage cavity of the bag body is in an airtight condition. However, the major drawback of such conventional zipper bag is that the attachment between the first and second zippers is not strong enough to retain the food inside the bag body. In other words, the first and second zippers are easily unfastened such that the bag body fails to provide the airtight condition for keeping the food freshly. Therefore, such integral type zipper bag can only be used as a sandwich bag that is not considered as a heavy-duty zipper bag.

The zip locker type zipper bag generally comprises a bag body, first and second zippers sealedly attached along the opening edges of the bag body respectively, and a zip locker engaged with the first and second zippers in a slidable manner that when the zip locker is slid to one side end of the bag body, the first and second zippers are unfastened, and when the zip locker is slid to another side end of the bag body, the first and second zippers are engaged to sealedly enclose the storage cavity in an airtight manner.

The method of producing the conventional zip locker type of the zipper bag comprises the steps of:

(a) deforming first raw materials to form a plastic sheet;

(b) overlappedly folding the plastic sheet along a longitudinal centerline to form a bag body;

(c) providing two transverse welding lines on the plastic sheet to form two sealing side edges of the bag body, wherein the bag body has a top opening defined between two longitudinal opening edges;

(d) providing a pair of elongated first and second zippers;

(e) attaching the first and second zippers along the two longitudinal opening edges of the bag body via an ultrasonic welding device, wherein two ends of the first and second zippers are welded together to form two stopper ends;

(f) slidably mounting a zip locker with the first and second zippers.

The advantage of such zipper bag is that each of the first and second zippers has a predetermined thickness such that when the first and second zippers are sealedly attached along the opening edges respectively, the thickness of each of the opening edges of the bag body is substantially increased so as to enhance the strength of the bag body around the opening. However, the attachment between the zippers and the bag body is not strong enough to seal the storage cavity of the bag body so that the weight of the food inside the bag body may accidentally break the attachment of the zipper bag. Moreover, the manufacturing cost of zipper bag will be highly increased by individually making the first and second zippers and attaching the first and second zippers along the opening edges of the bag body.

In addition, a major drawback of such zipper bag is that the zipper bag cannot provide a securely airtight zipping purpose. As shown in FIG. 1, when the zip locker is slid along the first and second zippers to enclose the storage cavity, a through hole H is unavoidably formed at a position between the zip locker and the respective stopper end so as to communicate the storage cavity with outside. In other words, air trapped in the bag body is allowed to release from the storage cavity to outside through the air hole, so that the zipper bag fails to provide an absolute air-sealing feature.

### SUMMARY OF THE PRESENT INVENTION

A main object of the present invention is to provide a built-in zipper bag and manufacturing method thereof, wherein a zipper arrangement is capable of securely zipping up a bag body of the zipper bag in an airtight manner.

Another object of the present invention is to provide a built-in zipper bag and manufacturing method thereof, wherein the first and second zipping fasteners of the zipper arrangement are integrally formed along two opening edges of the bag body such that the zipper bag not only provides a mounting rail along the opening edges of the bag body to enhance the strength thereof but also ensures the sealing attachment between the zipping fasteners and the bag body so as to prevent the zipper bag from being broken from the sealing attachment.

Another object of the present invention is to provide a built-in zipper bag and manufacturing method thereof, wherein the zipper bag has an air-sealing portion provided at a corner of the bag body to incorporate with the zipper arrangement in such a manner that when a zip locker is slid to fasten the first and second zipping fasteners, the zip locker is positioned at the air-sealing portion of the bag body to sealedly enclose the storage cavity of the bag body. In other words, when the zipper bag is in a zip locked condition, no air is allowed to release from the storage cavity of the bag body to outside so as to ensure the airtight feature of the zipper bag.

Another object of the present invention is to provide a method of producing a built-in zipper bag, wherein the manufacturing method does not require expensive machines and involved complicated structure so as to minimize the manufacturing cost of the zipper bag incorporating with the zipper arrangement.

Another object of the present invention is to provide a method of producing a built-in zipper bag, wherein the manufacturing method can simplify the conventional manufacturing method of the zipper bag so as to substantially reduce the time required for manufacture and to provide a lower cost of the zipper bag with enhanced zipping feature.

Accordingly, in order to accomplish the above objects the present invention provides a zipper bag, comprising:

a bag body having a storage cavity and an opening having two opening edges for communicating the storage cavity with outside; and

a zipper arrangement, comprising:

two zipping fasteners, which outer surface are integrally fused along the two opening edges of the bag body respectively, forming a pair of integral engagement rails,

first and second stopper ends formed at two ends of the zipper arrangement by attaching two end portions of one of the zipper fasteners with two corresponding end portions of the other zipper fastener respectively, and

a zip locker, having a guider arm, which is slidably mounted on the pair of sliding engagement rails and arranged in such a manner that when the zip locker is slid to the first stopper end of the zipper arrangement, the guider arm is slidably guided to unfasten the two zipping fasteners with each other so that the storage cavity is allowed to communicate with outside through the opening, and when the zip locker is slid to the second stopper end of the zipper arrangement, the two zipping fasteners are guided to engage with each other so as to enclose the storage cavity in an airtight manner.

The present invention further provides a method of producing the built-in zipper bag, comprising the steps of:

(a) forming a plastic sheet and a pair of elongated first and second zipper fasteners;

(b) integrally fusing outer surfaces of the first and second zipper fasteners along two longitudinal opening edges of the plastic sheet while forming the plastic sheet;

(c) overlappedly folding the plastic sheet along a longitudinal centerline to form the bag body wherein the two zipping fasteners are overlappedly aligned to form a pair of sliding engagement rails;

(d) providing two welding lines on the bag body to form two sealing side edges of the bag body respectively to form a storage cavity having an opening between the two zipper fasteners;

(e) forming first and second stopper ends at two ends of the pair of sliding engagement rails by attaching two end portions of one of the zipper fasteners with two corresponding end portions of the other zipper fastener respectively; and

(f) slidably mounting a zip locker on the pair of sliding engagement rails to slide between the two stopper ends, wherein the zip locker is arranged in such a manner that when the zip locker is slid to the first stopper end, the guider arm is slidably guided to unfasten the two zipping fasteners with each other so that the storage cavity is allowed to communicate with outside through the opening, and when the zip locker is slid to the second stopper end of the zipper arrangement, the two zipping fasteners are guided to engage with each other so as to enclose the storage cavity in an airtight manner.

### BRIEF DESCRIPTION OF THE DRAWINGS

FIG. 1 is a perspective view of a conventional zipper bag.

FIG. 2 is a perspective view of a built-in zipper bag according to a preferred embodiment of the present invention.

FIG. 3 is an exploded perspective view of a zipper arrangement of the built-in zipper bag according to the above preferred embodiment of the present invention.

FIG. 4 is a front view of the built-in zipper bag according to the above preferred embodiment of the present invention, illustrating the air-sealing portion of the bag body provided at the closing stopper end of the sliding rail.

FIG. 5 is a flow diagram illustrating a method of producing the built-in zipper bag according to the above preferred embodiment of the present invention.

### DETAILED DESCRIPTION OF THE PREFERRED EMBODIMENT

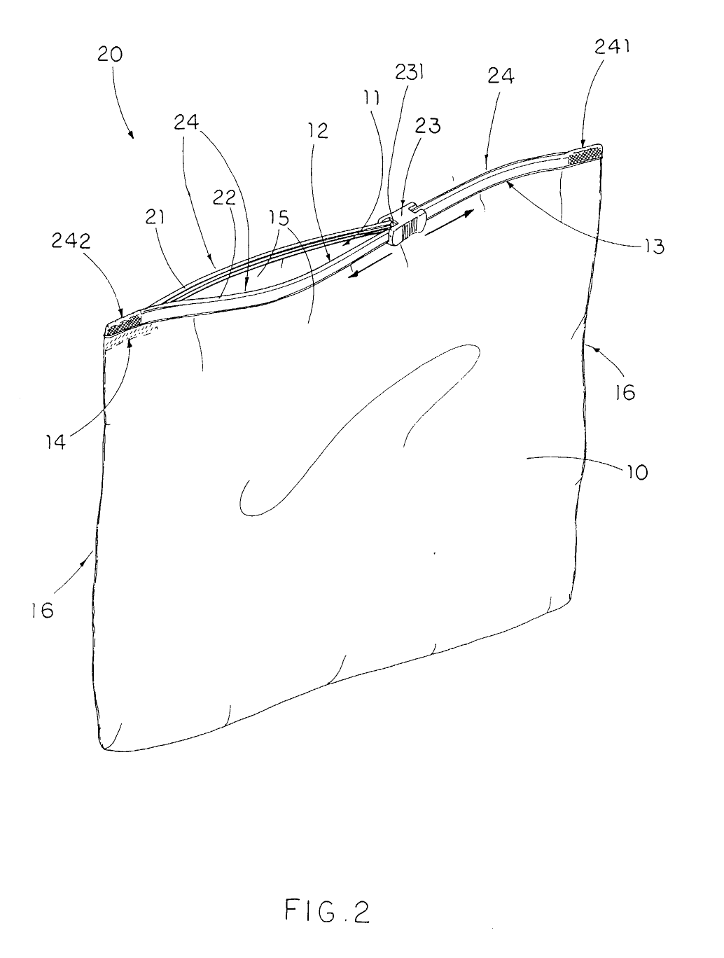

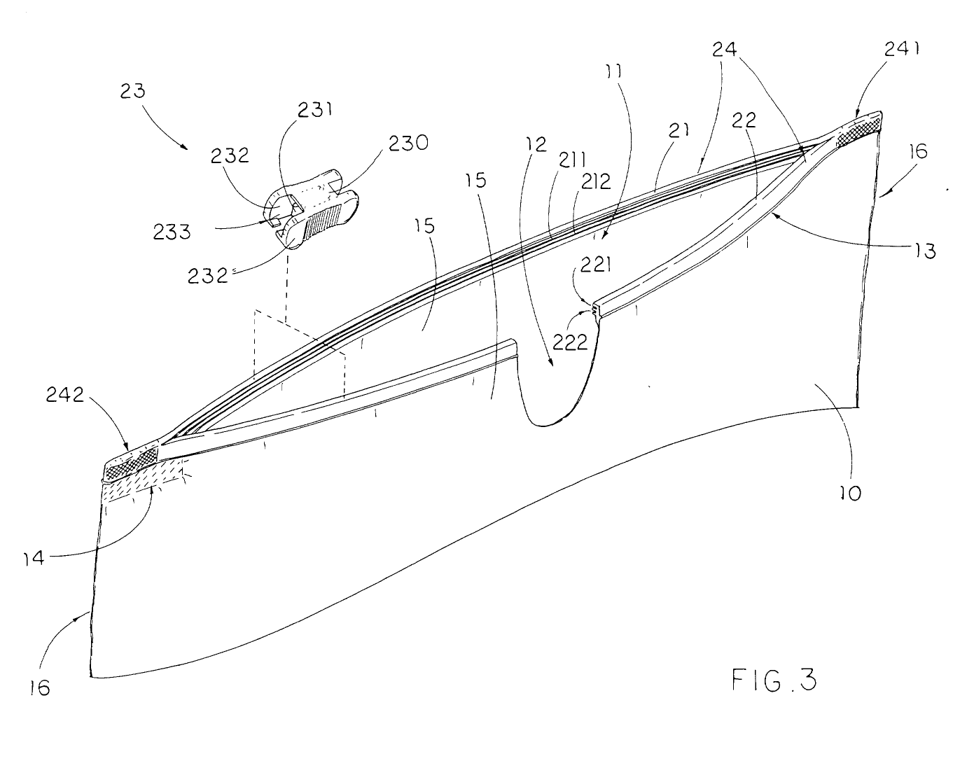

Referring to FIGS. 2 and 3 of the drawings, a built-in zipper bag according to a preferred embodiment of the present invention is illustrated, wherein the zipper bag comprises a bag body 10 having an opening 11 and a storage cavity 12, wherein the opening 11 has two opening edges 13 for communicating with the to the storage cavity 12 outside. The zipper bag further comprises a zipper arrangement 20 comprising two zipping fasteners 21, 22 and a zip locker 23.

According to the preferred embodiment, two outer surfaces of the two zipping fasteners 21, 22 are integrally fused along the two opening edges 13 of the bag body 10 respectively to form a pair of sliding engagement rails 24. The zipper arrangement 20 further includes a first and a second stopper end 241, 242 formed at two ends of the zipper arrangement 20 by attaching two end portions of one of the zipper fasteners 21 with two corresponding end portions of the other zipper fastener 22 respectively, wherein each of the zipping fasteners 21, 22 substantially increases a thickness of the respective opening edge 13 that thicker than a thickness of the bag body 10.

The zip locker 23, having a guider arm 231, is slidably mounted on the pair of sliding engagement rails 24 and arranged in such a manner that when the zip locker 23 is slid to the first stopper end 241 of the zipper arrangement 20, the guider arm 23 is slidably guided to unfasten the two zipping fasteners 21, 22 with each other so that the storage cavity 12 is allowed to communicate with outside through the opening 11, and when the zip locker 23 is slid to the second stopper end 242 of the zipper arrangement 20, the two zipping fasteners 21, 22 are guided to fasten with each other so as to enclose the storage cavity 12 in an airtight manner.

Accordingly, the bag body 10 is a plastic bag made of two plastic made overlapped layers 15 while two sealing side edges 16 of the bag body 10 is welded and sealed via an ultrasonic welding device S, wherein the storage cavity 12 is formed between the overlapped layers 15 in such a manner that the opening 11 is formed at the open side of the overlapped plastic sheet.

As shown in FIG. 3, the first zipping fastener 21 has two parallel engaging ribs 211, 212 longitudinally protruded along an inner surface thereof and the second zipper fastener 22 has two parallel engagement grooves 221, 222 formed along an inner surface thereof, wherein the zipper arrangement 20 can be fastened with each other by securely engaging the two engaging ribs 211, 222 into the two engagement grooves 221, 222 respectively while a pressing force is applied to press the two zipper fasteners 21, 22 together, and be unfastened by disengaging the two engaging ribs 211, 212 from the two engagement grooves 221, 222 receptively while a pulling force is applied to separate the two zipping fasteners 21, 22 apart from each other.

The zip locker 23 further comprises two pressing arms 232 connected by a top portion 230 and defined a locker groove 233 therebetween for riding on the pair of slidable engagement rails 24 while the two pressing arms 232 are slidably clamped at the two slidable engagement rails 24 so that the pair of slidable engagement rails 24 are capable of sliding through the locker groove 233. The guider arm 231 is downwardly protruded from the top portion 230 between the pressing arms 232 and extended in between the two zipper fasteners 21, 22, as shown in FIG. 2, such that when the zip locker 23 is slid towards the second stopper end 242 of the pair of sliding engagement rails 24, the pressing arms 232 press the zipping fasteners 21, 22 together to engage with each other so as to sealedly fasten the zipping fasteners 21, 22. Moreover, when the zip locker 23 is slid towards the first stopper end 241 of the pair of sliding engagement rails 24, the guider arm 231 forces the zipping fasteners 21, 22 to disengaged and separate from each other.

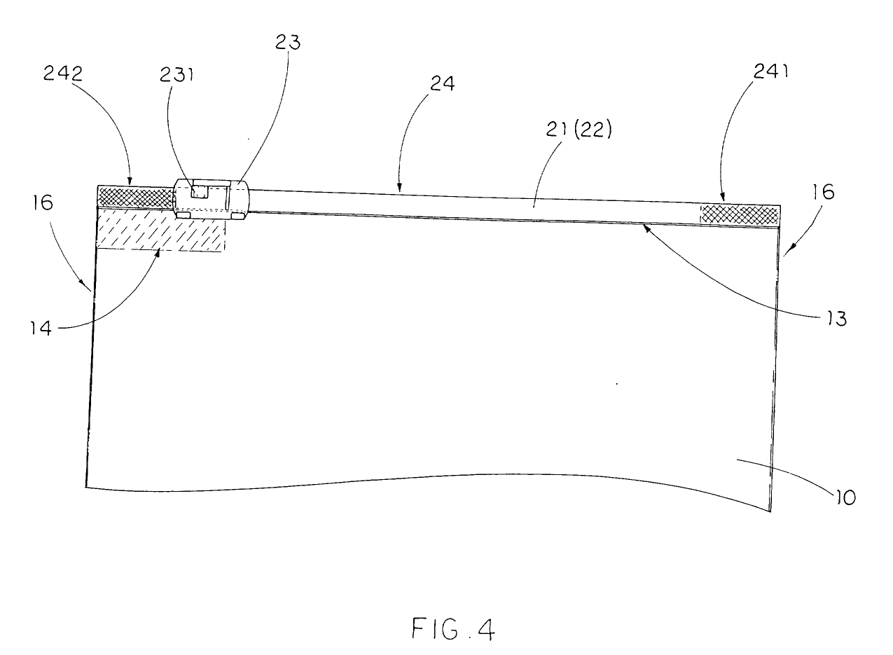

As shown in FIGS. 3 and 4, the bag body 10 further has an air sealing portion 14 provided at a position below the second stopper end 242 of the zipper arrangement 20 wherein the air sealing portion 14 is formed by sealedly attaching two corresponding portions of the two overlapped layers 15 of the bag body 10 together by welding in such a manner that no air is allowed to enter into the air sealing portion 14 of the bag body 10.

In addition, the air sealing portion 14 of the bag body 10 has a width larger than a distance between one of the sealing side edges of the bag body 10 and the guider arm 231 when the zip locker 23 is slid at the second stopper end 242 of the zipper arrangement, as shown in FIG. 4, so as to absolutely enclose the bag body 10 in an airtight manner.

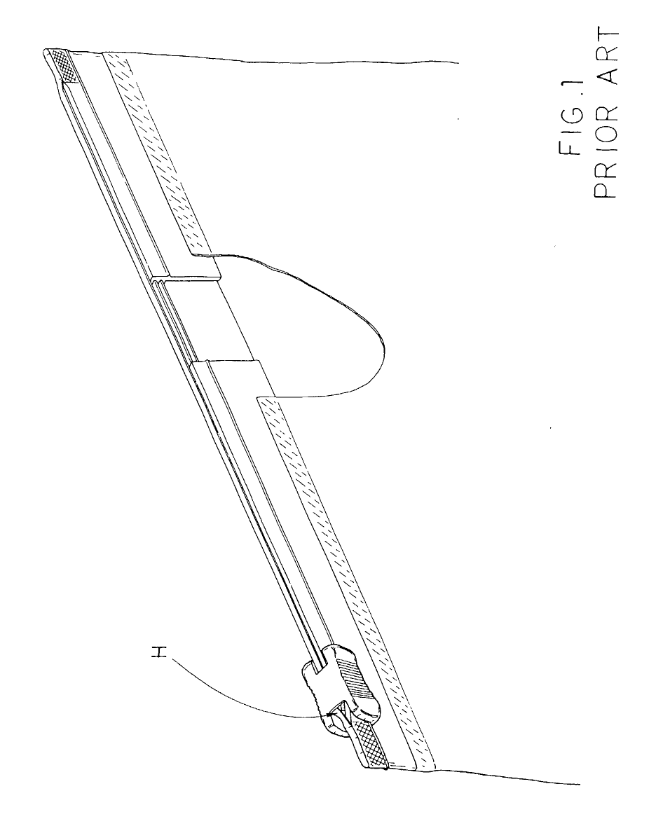

It is worth to mention that when the zip locker 23 is slid to the second stopper end 242 of the zipper arrangement 20, the zipping fasteners 21, 22 may not be entirely fastened with each other because an air hole H (as shown in FIG. 1) would still be formed between the second stopper end 242 and the zip locker 23. However, since the air sealing portion 14 of the bag body 10 is positioned right below the second stopper end 242, the air hole is blocked by the air sealing portion 14 so that no air is allowed to communicate between the storage cavity 12 with outside through the air hole. In other words, the air sealing portion 14 of the bag body 10 is capable of substantially blocking a communication between the storage cavity 12 to outside through the air hole when the zip locker 23 is slid to fastened at the second stopper end 242, so as to provide an absolute airtight feature of the zipper bag of the present invention.

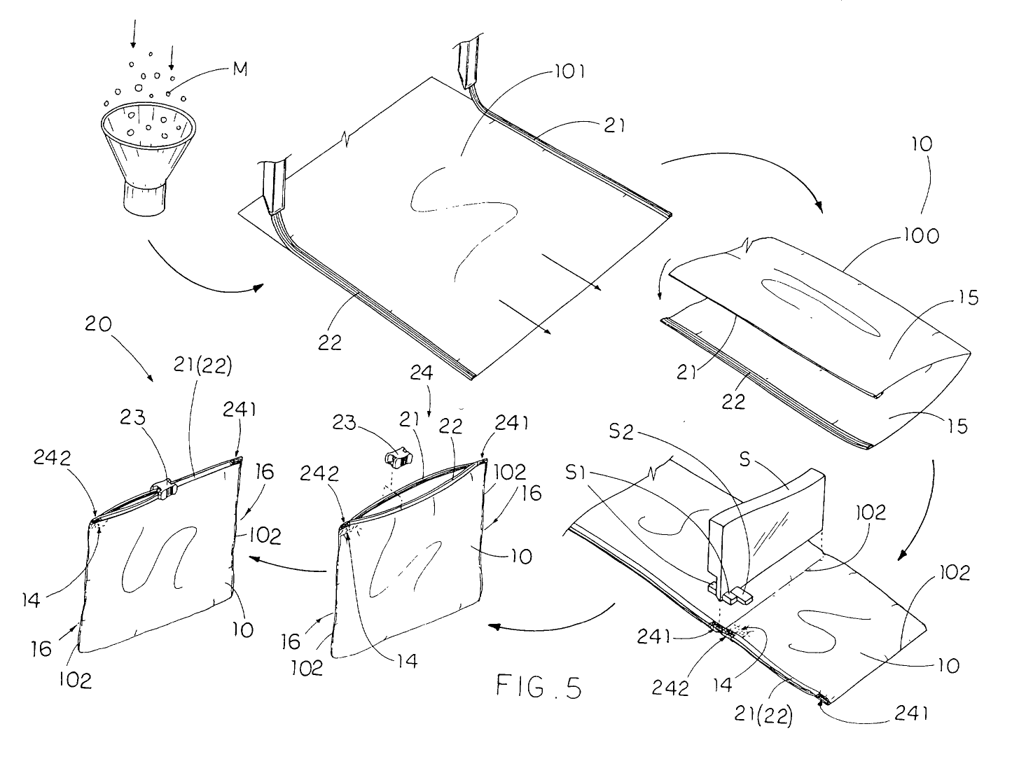

According to the preferred embodiment, the present invention further provides a method of producing the built-in zipper bag, as shown in FIG. 5, which comprises the following steps.

(1) Form an elongated plastic sheet 101 by deforming a raw material M and a pair of elongated first and second zipping fasteners 21, 22.

(2) Integrally fuse outer surfaces of the first and second zipper fasteners 21, 22 along two longitudinal opening edges 13 of the plastic sheet 101 while forming the plastic sheet 101.

(3) Overlappedly fold the plastic sheet 101 along a longitudinal centerline 100 to form the bag body 10 wherein the two zipping fasteners 21, 22 are overlappedly aligned to form a pair of sliding engagement rails 24.

(4) Provide two welding lines 102 on the bag body 10 to form two sealing side edges 16 of the bag body 10 respectively to form a storage cavity 12 having an opening 11 between the two zipper fasteners 21, 22.

(5) Form first and second stopper ends 241, 242 at two ends of the pair of sliding engagement rails 24 by attaching two end portions of one of the zipper fasteners 21 with two corresponding end portions of the other zipper fastener 22 respectively.

(6) Slidably mount the zip locker 23 on the pair of sliding engagement rails 24 to slide between two stopper ends 241, 242, wherein the zip locker 23 is arranged in such a manner that when the zip locker 23 is slid to the first stopper end 241 the guider arm 231 is slidably guided to unfasten the two zipping fasteners 21, 22 with each other so that the storage cavity 12 is allowed to communicate with outside through the opening 11, and when the zip locker 23 is slid to the second stopper end 242 of the zipper arrangement 20, the two zipping fasteners 21, 22 are guided to engage with each other so as to enclose the storage cavity 12 in an airtight manner.

In step (1), the elongated plastic sheet 101 is made of the plastic raw material M by injection molding techniques. When molding the plastic sheet 101, the two zipping fasteners 21, 22 are also molded and integrally fused along the two longitudinal edges of the plastic sheet 101. Since each of the zipping fasteners 21, 22 has a predetermined thickness, each longitudinal edge of the plastic sheet 101, i.e. the opening edges 13 of the bag body 10, substantially increases its thickness. Therefore, the zipping fasteners 21, 22 substantially form as a reinforcing rim of the bag body 10 to enhance the strength thereof. Moreover, the integral sealing attachment of the zipping fasteners 21, 22 can ensure the airtight feature of the bag body 10 to substantially prevent air leaking along the sealing attachment of the zipper arrangement 20.

In step (2), the centerline 100 of the plastic sheet 101 is defined at a line between the two longitudinal edges of the plastic sheet 101 so as to divide the plastic sheet 101 into two identical halves. The plastic sheet 101 is then overlappedly folded along the centerline 100 in such a manner that the overlapped plastic sheet 101 is constructed to be the two overlapped layers 15 of the bag body 10. Moreover, the zipping fasteners 21, 22 are overlappedly aligned with each other to form the pair of sliding engagement rails 24. Preferably, when the plastic sheet 101 is overlapped folded the zipping fasteners 21, 22 are sealedly fastened with each other so as to retain the shape of the plastic sheet 101 in an overlapped manner.

In step (3), an ultrasonic welding device S is used to weld a pair of parallel welding lines 102 spaced apart to form the two sealing side edges 16 of the bag body 10. Accordingly, the welding line 102 can be formed by thermal cut that cuts the plastic sheet 101 into sections and seals the two neighbor side edges.

In order to form the stopper ends 241, 242 of the pair of sliding engagement rails 24, the welding device S further has a welding tip mold S1 arranged in such a manner that when the welding device S is pressed on the bag body 10 to form the welding line 102 thereon, the welding tip mold S1 is pressed at two adjacent end portions of the zipping fasteners 21, 22, so as to sealedly attach the end portions of the zipping fasteners 21, 22 together, as shown in FIG. 5. In other words, no additional step is required to form the stopper ends 241, 242 of the pair of sliding engagement rails 24 while providing the welding lines 102 on the bag body 10.

Therefore, after the bag body 10 is formed with built-in zipping fasteners 21, 22, the zip locker 23 is slidably mounted on the pair of sliding engagement rails 24, so as to complete the manufacturing process of the zipper bag of the present invention. It is worth mentioning that in comparison with the conventional manufacturing process as mentioned in background, the present invention substantially simplifies the process of making the zipping fasteners 21, 22 individually and attaching the zipping fasteners 21, 22 along the side edge of the plastic sheet 101. Therefore, the present invention not only lower the manufacturing cost of the zipper bag but also reduce the required manufacturing time of the zipper bag.

According to the present invention, the step (3) further comprises a sub-step of providing the air-sealing portion 14 of the bag body 10. As shown in FIG. 5, the welding device S further comprises a welding mold head S2 arranged to press on the bag body 10 at a position below the closing stopper end 242 of the pair of sliding engagement rails 24 so as to sealedly attach the overlapped layers 15 of the bag body 10 at such position together in an airtight manner. Therefore, an one-step sealing process of the zipper bag, including the welding line 102, the stopper ends 241, 242, and the air-sealing portion 14, is performed at the same time so as to minimize the steps required to manufacture the zipper bag.

While the forgoing description and figures describe the first and second embodiments and their alternatives of the present invention, it should be appreciated that certain obvious modification, variations, and substitutions may be made without departing from the spirit and scope of the present invention. For example, the injection molding technique for the plastic sheet 101 and the welding technique can be altered in order to corporate the bag body 10 with the zipper arrangement 20.

What is claimed is:

1. A zipper bag, comprising:
a bag body having a storage cavity and an opening having two opening edges for communicating said storage cavity with outside; and
a zipper arrangement, comprising:
two zipping fasteners which outer surface are integrally fused along said two opening edges of said bag body respectively to form a pair of integral engagement rails along two top sides of said bag body,
first and second stopper ends formed at two ends of said zipper arrangement by attaching two end portions of one of said zipper fasteners with two corresponding end portions of said other zipper fastener respectively, and
a zip locker, having a guider arm, which is slidably mounted on said pair of sliding engagement rails and arranged in such a manner that when said zip locker is slid to said first stopper end of said zipper arrangement, said guider arm is slidably guided to unfasten said two zipping fasteners with each other so that said storage cavity is allowed to communicate with outside through said opening, and when said zip locker is slid to said second stopper end of said zipper arrangement, said two zipping fasteners are guided to engage with each other so as to enclose said storage cavity in an airtight manner.

2. The zipper bag, as recited in claim 1, wherein said bag body further has an air sealing portion provided at a position below said second stopper end of said zipper arrangement, wherein said air sealing portion is formed by sealedly attaching two corresponding portions of said two overlapped layers of said bag body together such that no air is allowed to enter into said air sealing portion of said bag body.

3. The zipper bag, as recited in claim 2, wherein said air sealing portion of said bag body has a width larger than a distance between one of said sealing side edges of said bag body and said guider arm when said zip locker is slid at said second stopper end of said zipper arrangement so as to absolutely enclose said bag body in an airtight manner.

4. The zipper bag, as recited in claim 2, wherein said air sealing portion is formed by ultrasonic welding.

5. The zipper bag, as recited in claim 1, wherein said zipping fasteners are formed by molding said zipping fasteners at two opening edges of said bag body while producing said bag body so as to integrally fuse said zipping fasteners with said bag body to form the zipper bag.

6. The zipper bag, as recited in claim 2, wherein said zipping fasteners are formed by molding said zipping fasteners at two opening edges of said bag body while producing said bag body so as to integrally fuse said zipping fasteners with said bag body to form the zipper bag.

7. The zipper bag, as recited in claim 3, wherein said zipping fasteners are formed by molding said zipping fasteners at two opening edges of said bag body while producing said bag body so as to integrally fuse said zipping fasteners with said bag body to form the zipper bag.

8. The zipper bag, as recited in claim 3, wherein said first and second stopper ends are formed by sealedly welding said end portions of said zipping fasteners together respectively.

9. The zipper bag, as recited in claim 7, wherein said first and second stopper ends are formed by sealedly welding said end portions of said zipping fasteners together respectively.

10. The zipper bag, as recited in claim 1, wherein said zipper bag is constructed by the steps of:
(a) forming a plastic sheet and said first and second zipper fasteners;
(b) integrally fusing outer surfaces of said first and second zipper fasteners along two longitudinal opening edges of said plastic sheet while forming said plastic sheet;
(c) overlappedly folding said plastic sheet along a longitudinal centerline to form said bag body wherein said two zipping fasteners are overlappedly aligned to form said pair of sliding engagement rails;
(d) providing two welding lines on said bag body to form two sealing side edges of said bag body respectively to define said storage cavity within said bag body that has an opening between said two zipper fasteners;
(e) forming said first and second stopper ends at two ends of said pair of sliding engagement rails by attaching said two end portions of said first zipper fastener with said two end portions of said second zipper fastener respectively; and
(f) slidably mounting said zip locker on said pair of sliding engagement rails to slide between said two stopper ends.

11. The zipper bag, as recited in claim 10, wherein the step (d) further comprises a step of forming an air-sealing portion on said bag body, wherein said air sealing portion is positioned below said second stopper end of zipper arrangement by sealedly attaching two corresponding portions of said plastic sheet in an overlapped manner together such that no air is allowed to enter into said air-sealing portion of said bag body.

12. The zipper bag, as recited in claim 11, wherein said air sealing portion of said bag body has a width larger than a distance between one of said sealing side edges of said bag body and said guider arm when said zip locker is slid at said second stopper end of said zipper arrangement so as to absolutely enclose said bag body in an airtight manner.

13. The zipper bag as recited in claim 10, in the step (e), wherein said first and second stopper ends are formed by sealedly welding said end portions of said zipping fasteners together respectively.

14. The zipper bag as recited in claim 12, in the step (e), wherein said first and second stopper ends are formed by sealedly welding said end portions of said zipping fasteners together respectively.

15. A method of making a zipper bag, comprising the steps of:
(a) forming an elongated plastic sheet and a pair of elongated first and second zipping fasteners;
(b) integrally fusing outer surfaces of said first and second zipper fasteners along two longitudinal opening edges of said plastic sheet while forming said plastic sheet;
(c) overlappedly folding said plastic sheet along a longitudinal centerline to form a bag body wherein said first and second zipping fasteners are overlappedly aligned to form a pair of sliding engagement rails;
(d) providing two welding lines on said bag body to form two sealing side edges of said bag body respectively to form a storage cavity having an opening between said first and second zipper fasteners;
(e) forming first and second stopper ends at two ends of said pair of sliding engagement rails by attaching two end portions of said first zipper fastener with two end portions of said second zipper fastener respectively; and
(f) slidably mounting said zip locker on said pair of sliding engagement rails to slide between two stopper ends, wherein said zip locker is arranged in such a manner that when said zip locker is slid to said first stopper end said guider arm is slidably guided to unfasten said first and second zipping fasteners with each other, and when said zip locker is slid to said second stopper end of said zipper arrangement, said two zipping fasteners are guided to engage with each other so as to enclose said storage cavity in an airtight manner.

16. The method, as recited in claim 15, in the step (c), further comprising a step of:
(c.1) forming an air-sealing portion on said bag body, wherein said air sealing portion is positioned below said second stopper end of zipper arrangement by sealedly attaching two corresponding portions of said plastic sheet in an overlapped manner together such that no air is allowed to enter into said air-sealing portion of said bag body.

17. The zipper bag, as recited in claim 16, wherein said air sealing portion of said bag body has a width larger than a distance between one of said sealing side edges of said bag body and said guider arm when said zip locker is slid at said second stopper end of said zipper arrangement so as to absolutely enclose said bag body in an airtight manner.

18. The zipper bag as recited in claim 15, in the step (e), wherein said first and second stopper ends are formed by sealedly welding said end portions of said Zipping fasteners together respectively.

19. The zipper bag as recited in claim 16, in the step (e), wherein said first and second stopper ends are formed by sealedly welding said end portions of said zipping fasteners together respectively.

20. The zipper bag as recited in claim 17, in the step (e), wherein said first and second stopper ends are formed by sealedly welding said end portions of said zipping fasteners together respectively.
